(19) United States
(12) Patent Application Publication
(10) Pub. No.: US 2016/0263665 A1
(43) Pub. Date: Sep. 15, 2016

(54) COMPOSITE BLANKS AND TOOLING FOR CUTTING APPLICATIONS

(71) Applicant: Kennametal lnc., Latrobe, PA (US)

(72) Inventors: Pankaj Kumar MEHROTRA, Greensburg, PA (US); Neal MYERS, Greensburg, PA (US); Richard J. GUBANICH, Delmont, PA (US); Edward Tracy REBTOY, Latrobe, PA (US)

(21) Appl. No.: 14/644,939

(22) Filed: Mar. 11, 2015

(51) Int. Cl. B23B 51/06; B23P 15/32; B23B 27/10; B23P 15/30

(52) U.S. Cl. CPC B23B 51/06; B23P 15/30; B23P 15/32; B23B 27/10; B23B 2222/28; B23B 2250/12; B23B 2240/08

(57) ABSTRACT

In one aspect, composite blanks and tooling are described herein employing composite structures for efficient use of high grade materials, such as high grade sintered cemented carbides and/or ceramics.

### FIELD

The present invention relates to blanks and other tooling for cutting and/or wear applications and, in particular, to blanks and tooling having composite architectures.

### BACKGROUND

Tungsten is an industrially significant metal finding application in a variety of fields with particular emphasis in the tooling industry. The high hardness, heat resistance and wear resistance of tungsten and its carbide make it an ideal candidate for use in cutting tools, mining and civil engineering tools and forming tools, such as molds and punches. Cemented tungsten carbide tools, for example, account for the majority of worldwide tungsten consumption. According a 2007 United States Geological Survey, mineral deposits of tungsten resources totaled in the neighborhood of nearly 3 million tons. At current production levels, these resources will face exhaustion within the next forty years. Moreover, a handful of nations control the majority of worldwide tungsten deposits. China, for example, controls approximately 62% of tungsten deposits and accounts for 85% of ore production volume. In view of this inequitable global distribution and associated exhaustion projections, new tooling architectures are required that emphasize efficient use of tungsten and tungsten carbide.

### SUMMARY

In one aspect, blanks for rotary tooling applications are described herein. Such blanks employ a composite structure for efficient use of high grade materials. In some embodiments, for example, the composite blanks are in near net shape form, thereby minimizing material and time lost in machining operations for preparation of fluted structures and cutting edges. A composite blank described herein comprises a hollow shank portion extending along a central longitudinal axis of the blank and a cutting portion extending from the hollow shank portion. The cutting portion comprises flutes along an axial length of cut and one or more interior coolant channels extending along the central longitudinal axis and terminating at a cutting end surface of the blank. The cutting portion of the blank is formed of a first material along the axial length of cut differing in at least one property from a second material forming the hollow shank portion.

In some embodiments, the first material forming the cutting portion is cemented carbide. The second material of the hollow shank can also be cemented carbide differing from the first material in composition, particle size and/or porosity. Alternatively, the second material can be steel or other alloy. Further, the hollow shank portion and the cutting portion of the blank can be continuous with one another. In other embodiments, a braze joint exists between the hollow shank portion and cutting portion.

Methods of making composite blanks are also described herein. In some embodiments, a method of making a composite blank comprises forming a cutting portion of the blank from a first material, the cutting portion comprising flutes along an axial length of cut and one or more coolant channels extending along a central longitudinal axis of the blank. A hollow shank portion is formed from a second material and coupled to the cutting portion, wherein the first material of the cutting portion differs from the second material in at least one property. In some embodiments, the hollow shank portion and cutting portion are coupled by sintering to provide a composite blank of monolithic structure. Alternatively, the hollow shank portion and cutting portion are coupled by a braze joint.

In another aspect, cutting inserts are described herein. Such cutting inserts can also employ a composite architecture for efficient use of high grade materials. A composite cutting insert comprises at least one non-working portion and at least one working portion extending from the non-working portion. The working portion includes one or more interior coolant channels and is formed of a first material differing in at least one property from a second material forming the non-working portion. In some embodiments, the working portion and the non-working portion are continuous with one another, wherein the non-working portion contacts a holder for the cutting insert.

Methods of making composite cutting inserts are also described herein. A method of making a composite cutting insert comprises providing a core structure and consolidating a powder composition around the core structure, the powder composition comprising a first grade powder and a second grade powder. The consolidated powder composition is sintered to provide a working portion of the cutting insert formed of sintered first grade powder and a non-working portion formed of sintered second grade powder, wherein the sintered first grade powder differs from the sintered second grade powder in at least one property. Further, the core structure is removed to provide one or more interior coolant channels in the working portion. In some embodiments, the core structure is removed following consolidation of the powder composition and prior to sintering. Alternatively, the core structure can be removed by the sintering process, such as by melting or decomposition.

These and other embodiments are described in greater detail in the detailed description which follows.

### BRIEF DESCRIPTION OF THE DRAWINGS

FIG. 1 illustrates a composite blank according to one embodiment described herein.

FIG. 2 illustrates a composite blank according to one embodiment described herein.

FIG. 3 illustrates a composite blank according to one embodiment described herein.

FIG. 4 illustrates a composite blank according to one embodiment described herein.

FIG. 5 illustrates a composite blank according to one embodiment described herein.

FIG. 6 illustrates a composite cutting insert according to one embodiment described herein.

FIG. 7 illustrates a composite cutting insert coupled to an end of a rotary cutting tool according to one embodiment described herein.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

### I. Composite Blanks

In one aspect, blanks for rotary tooling applications are described herein. Such blanks employ a composite structure for efficient use of high grade materials, such as high grade sintered cemented carbides and/or ceramics. In some embodiments, for example, the composite blanks are in near net shape form, thereby minimizing material and time lost in machining operations for preparation of fluted structures and cutting edges. A composite blank described herein comprises a hollow shank portion extending along a central longitudinal axis of the blank and a cutting portion extending from the hollow shank portion. The cutting portion comprises flutes along an axial length of cut and one or more interior coolant channels extending along the central longitudinal axis and terminating at a cutting end surface of the blank. The cutting portion of the blank is formed of a first material along the axial length of cut differing in at least one property from a second material forming the hollow shank portion. In some embodiments, the first material and the second material are compositionally different. For example, the first material can be cemented carbide or ceramic and the second material can be steel or cermet.

Alternatively, the first material of the cutting portion is a first cemented carbide and the second material of the hollow shank portion is a second cemented carbide. In such embodiments, the first cemented carbide differs from the second cemented carbide in at least one property, such as composition, average particle size and porosity. For example, when differing in composition, the first cemented carbide can generally comprise cubic carbides in an amount less than 0.3 weight percent with the second cemented carbide comprising cubic carbides in an amount greater than 0.3 weight percent. Additionally, the first cemented carbide can compositionally differ from the second cemented carbide in metallic binder content and/or distribution. The first cemented carbide, in some embodiments, employs a lower amount of metallic binder than the second cemented carbide. The first cemented carbide can also exhibit a metallic binder distribution of greater uniformity than the second cemented carbide.

The first cemented carbide can also differ from the second cemented carbide in average particle size. In some embodiments, the first cemented carbide has an average particle size less than the second cemented carbide. For example, the first cemented carbide can have an average particle size of 0.8 μm to 2 μm, and the second cemented carbide can have an average particle size of 0.6 μm to 5 μm. Additionally, the first cemented carbide can differ from the second cemented carbide in porosity. In some embodiments, the second cemented carbide exhibits higher porosity than the first cemented carbide.

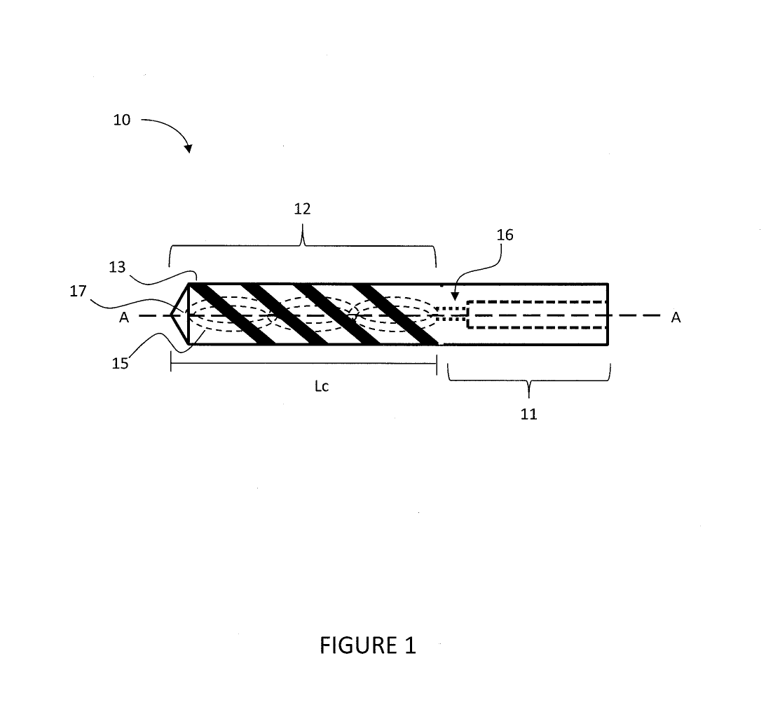

FIG. 1 illustrates a composite blank according to one embodiment described herein. The composite blank (10) of FIG. 1 comprises a hollow shank portion (11) extending along a central longitudinal axis (A-A) of the blank (10) and a cutting portion (12) extending from the hollow shank portion (11), wherein the cutting portion (12) is formed of a first material differing in at least one property from the second material forming the hollow shank portion (11). The cutting portion (12) comprises flutes (13) along the axial length of cut (L_{c}) and interior helical coolant channels (15) extending along the central longitudinal axis (A-A). The helical coolant channels (15) are in fluid communication with a fluid inlet channel (16) from the hollow shank portion (11). Further, the helical coolant channels (15) terminate in a cutting end (17) of the composite blank (10). In being formed of the first material, the cutting portion (12) is operable to provide uniform or substantially uniform cutting results along the axial length of cut (L_{c}). This contrasts with other rotary tooling where only the tip of the rotary tool is formed of hard material and the remaining material along the axial length exhibits differing compositional and/or wear properties.

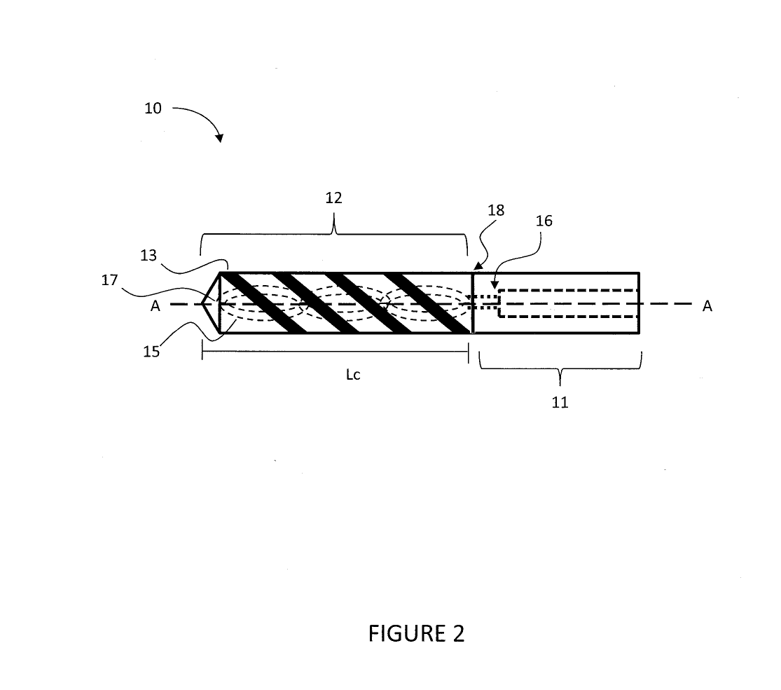

In the embodiment of FIG. 1, the hollow shank portion (11) and cutting portion (12) are continuous with one another, providing the blank (10) a monolithic structure. Such continuous structure, in some embodiments, is achieved by cosintering the hollow shank portion (11) and cutting portion (12). Alternatively, the hollow shank portion (11) can be coupled to the cutting portion (12) by a braze joint (18) as illustrated in FIG. 2.

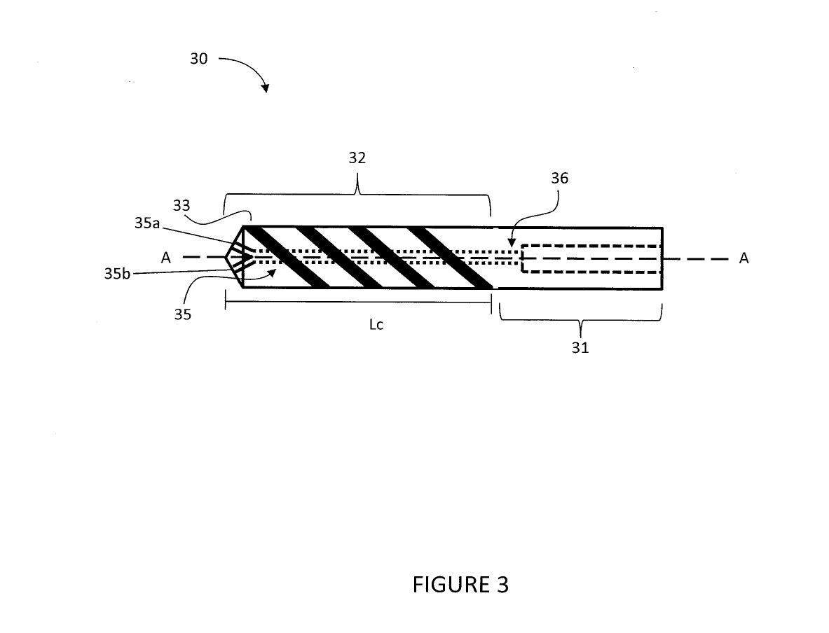

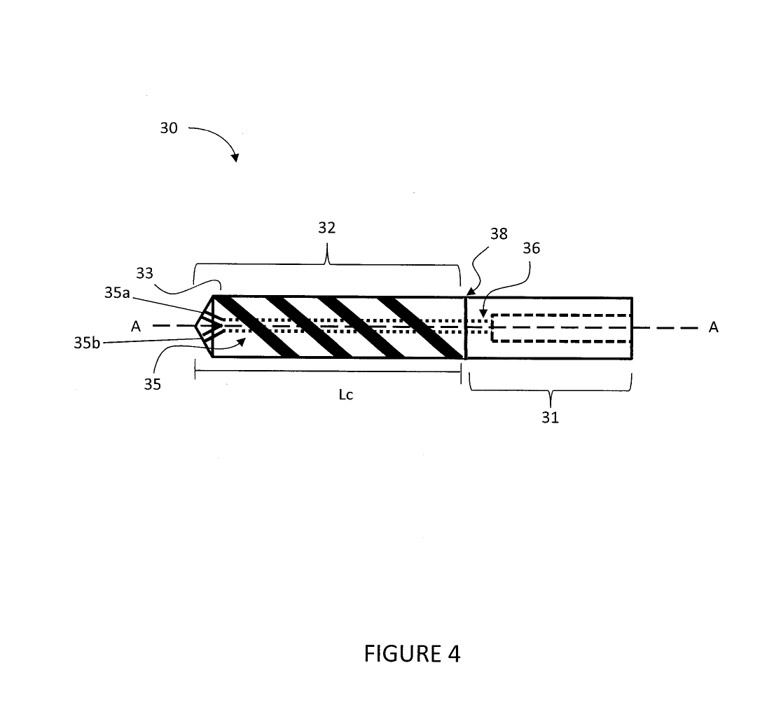

FIG. 3 illustrates another embodiment of a composite blank described herein. The composite blank (30) of FIG. 3 exhibits the structural components described in FIG. 1, including a hollow shank portion (31) and cutting portion (32) having flutes (33) along the axial length of cut (L_{c}). However, the composite blank (30) of FIG. 3 incorporates a linear interior coolant channel (35) extending along the longitudinal axis (A-A). The linear coolant channel (35) splits into two coolant outlet channels (35a, 35b) proximate the cutting end of the composite blank (30) and is in fluid communication with a fluid inlet channel (36) from the hollow shank portion (31). The two coolant outlet channels (35a, 35b) can be split at any desired angle not inconsistent with the objectives of the present invention. In some embodiments, the two coolant outlet channels (35a, 35b) split at an angle greater than 90 degrees. Alternatively, the two coolant channels (35a, 35b) split at an angle less than or equal to 90 degrees. Similar to FIG. 1, the hollow shank portion (31) and the cutting portion (32) of FIG. 3 are continuous with one another, providing a monolithic blank (30). Alternatively, the hollow shank portion (31) is coupled to the cutting portion (32) by a braze joint (38) as illustrated in FIG. 4.

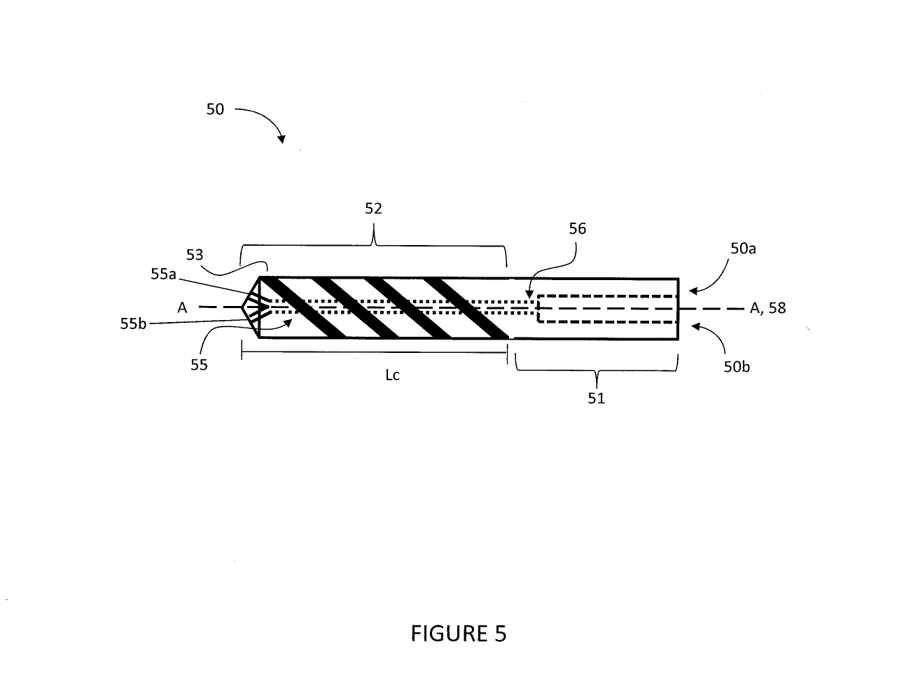

FIG. 5 illustrates an alternative brazing construction for a composite blank described herein. The composite blank (50) of FIG. 5 has a structure similar to the composite blank (30) of FIG. 4. However, the braze joint (58) extends along the central longitudinal axis (A-A), dividing the composite blank (50) into longitudinal halves (50a, 50b). The braze joint (58), in some embodiments, can follow the circumference of the linear coolant channel (55) and cavity (59) of the hollow shank portion (51).

Methods of making composite blanks are also described herein. In some embodiments, a method of making a composite blank comprises forming a cutting portion of the blank from a first material, the cutting portion comprising flutes along an axial length of cut and one or more coolant channels extending along a central longitudinal axis of the blank. A hollow shank portion is formed from a second material and coupled to the cutting portion, wherein the first material differs from the second material in at least one property.

In some embodiments, the hollow shank portion and cutting portion are coupled by cosintering to provide a composite blank of monolithic structure. When cosintered to provide a monolithic structure, the hollow shank portion and the cutting portion can be in green form prior to cosintering. For example, the cutting portion and the hollow shank portion can be green formed by at least one of extrusion, molding and pressing. Powder first material can be extruded, molded and/or pressed to provide the green cutting portion. Structural features of the cutting portion, including the flutes and/or interior coolant channels can be provided in the extrusion, molding or pressing operation. In some embodiments, the green cutting portion can be machined to provide one or more structural features, including the flutes and/or interior coolant channels. Similarly, powder second material can be extruded, molded and/or pressed to provide the hollow shank portion. The hollow structure of the shank portion can be provided by any of these forming processes. The green hollow shank portion may also be mechanically worked or machined to provide desired structural features.

The powder first material of the green cutting portion can be a first carbide grade, and the powder second material of the hollow shank portion can be a second carbide grade. When sintered, the first carbide grade provides a first cemented carbide, and the second carbide grade provides a second cemented carbide, wherein the first cemented carbide differs from the second cemented carbide in at least one property. The first and second cemented carbides, for example, may differ in composition, average particle size and/or porosity as described hereinabove.

Alternatively, the powder first material and powder second material can be materials of different classes. The powder first material, for example, can be a first carbide grade and the second powder material can be powder alloy, such as that used in high speed tool steel fabrication. In other embodiments, the powder first material can be a ceramic including, but not limited to, silicon nitride, SiAlON, silicon carbide, silicon carbide whisker containing alumina or mixtures thereof. In such embodiments, the powder second material can be a second carbide grade or powder alloy for pairing with the ceramic powder first material.

The green cutting portion and the green hollow shank portion can be joined by cosintering to provide a monolithic composite blank. Structural features introduced to the cutting portion during the green forming process can place the composite blank in near net shape form, thereby minimizing additional processing such as flute and cutting edge preparation.

As described herein, the cutting portion and the hollow shank portion may also be coupled by a braze joint. In such embodiments, the cutting portion and hollow shank portion can be formed independent of one another and then coupled by the braze joint. For example, the cutting portion can be green formed and sintered as described above, while the hollow shank portion is turned from a steel workpiece having a hollow core. Further, the cutting portion and/or hollow shank portion can be provided one or more structures to facilitate brazing. In some embodiments, for example, the cutting portion and hollow shank portion are provided male/female structures, such as key ways or slots, to facilitate alignment and coupling.

### II. Cutting Inserts

In another aspect, cutting inserts are described herein. Such cutting inserts can employ a composite structure for efficient use of high grade materials. A composite cutting insert comprises at least one non-working portion and at least one working portion extending from the non-working portion. The working portion includes one or more interior coolant channels and is formed of a first material differing in at least one property from a second material forming the non-working portion. In some embodiments, the working portion and the non-working portion are continuous with one another, wherein the non-working portion contacts a holder for the cutting insert. First and second materials forming respective working and non-working portions of the composite cutting insert can have compositional parameters and properties described in Section I hereinabove. The first material, for example, may be a first cemented carbide or ceramic and the second material may be a second cemented carbide or steel. First and second cemented carbides may differ from one another in composition, average particle size and/or porosity as described in Section I. Cutting inserts having a composite architecture described herein can be indexable cutting inserts or inserts having geometry for completing the cutting end of a rotary cutting tool.

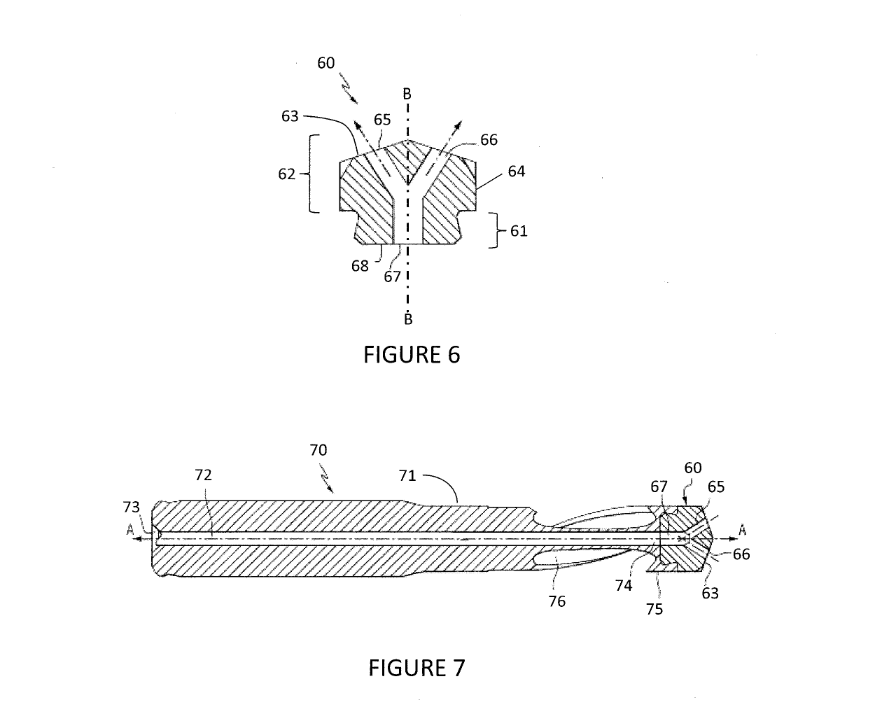

FIG. 6 illustrates a cross-sectional view of a composite cutting insert according to one embodiment described herein. As illustrated in FIG. 6, the composite cutting insert (60) comprises a non-working portion (61) and a working portion (62) extending from the non-working portion (61) along longitudinal axis B-B. The working portion (62) includes forward cutting edges (63) and side cutting edges (64) formed of a first material differing in at least one property from a second material forming the non-working portion (61). As illustrated in FIG. 6 herein, the non-working portion (61) includes a base (68) and is configured to contact or engage a holder for the insert (60). Interior coolant channels (65, 66) pass through the working portion (62) and terminate at the cutting end of the insert (60). The coolant channels (65, 66) are fed by an inlet channel (67) passing through the non-working portion (61). In an alternative arrangement, coolant channels (65, 66) can also pass through the non-working portion (61) and are fed by independent inlet channels from the tool body to which the cutting insert (60) is coupled. The working (62) and non-working portions (61) are continuous with one another providing the cutting insert (60) a monolithic structure.

FIG. 7 illustrates a cross-sectional view of the composite cutting insert of FIG. 6 coupled to an end of a rotary cutting tool according to one embodiment described herein. The rotary tool body (71) defines flutes (76) and an interior coolant channel (72) extending along the central longitudinal axis A-A. The interior coolant channel (72) has an inlet at a first end (73) of the rotary cutting tool (70) and terminates at a second end (74) adjacent to a pocket (75) for receiving the composite cutting insert (60). The interior coolant channel (72) is aligned with and feeds the inlet channel (67) of the composite cutting insert (60). As in FIG. 6, the inlet channel (67) is in fluid communication with the interior coolant channels (65, 66) passing through the working portion of the cutting insert (60).

Methods of making composite cutting inserts are also described herein. A method of making a composite cutting insert comprises providing a core structure and consolidating a powder composition around the core structure, the powder composition comprising a first grade powder and a second grade powder. The consolidated powder composition is sintered to provide a working portion of the cutting insert formed of sintered first grade powder and a non-working portion formed of sintered second grade powder, wherein the sintered first grade powder differs from the sintered second grade powder in at least one property and the core structure is removed to provide one or more interior coolant channels in the working portion. As described herein, the sintered first grade powder and the sintered second grade powder can differ in composition, average particle size and/or porosity.

In some embodiments, the core structure is removed following consolidation of the powder composition and prior to sintering. For example, one or more pins or similar structures can be employed for coolant passage fabrication. Upon completion of green forming, the core is pulled or otherwise removed, and the green part is sintered. Alternatively, the core is not removed prior to sintering. In such embodiments, the core can be melted or decomposed in the sintering process to provide the interior coolant passages. Cores of desired geometry can be fabricated by a variety of processes including, but not limited to, machining, extrusion, molding and/or additive manufacturing.

Importantly, the present method of using core structures for interior coolant channel formation is not limited to cutting inserts. Methods described herein can be applicable to a variety of cutting and/or wear tools incorporating interior coolant channels. Further, cores can be used to provide interior structures other than coolant passages in working and/or non-working portions of cutting and/or wear tooling.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

1. A composite blank comprising:
a hollow shank portion extending along a central longitudinal axis of the blank; and
a cutting portion extending from the hollow shank portion, the cutting portion comprising flutes along an axial length of cut and one or more interior coolant channels extending along the central longitudinal axis and terminating at a cutting end surface of the blank, wherein the cutting portion is formed of a first material along the axial length of cut differing in at least one property from a second material forming the hollow shank portion.

2. The composite blank of claim 1, wherein the hollow shank portion and cutting portion are continuous with one another.

3. The composite blank of claim 1 further comprising a braze joint between the hollow shank portion and cutting portion.

4. The composite blank of claim 1, wherein the one or more interior coolant channels extend helically along the longitudinal axis.

5. The composite blank of claim 1, wherein the one or more interior coolant channels extend linearly along the longitudinal axis.

6. The composite blank of claim 1, wherein the first material is a first cemented carbide and the second material is a second cemented carbide.

7. The composite blank of claim 6, wherein the first cemented carbide differs from the second cemented carbide in composition.

8. The composite blank of claim 7, wherein the first cemented carbide comprises cubic carbides in an amount less than 0.3 wt. %, and the second cemented carbide comprises cubic carbides in an amount greater than 0.3 wt. %.

9. The composite blank of claim 6, wherein the first cemented carbide and the second cemented carbide differ in average particle size.

10. The composite blank of claim 9, wherein the first cemented carbide has an average particle size of 0.8 μm to 2 μm, and the second cemented carbide has an average particle size of 0.6 to 5 μm.

11. The composite blank of claim 6, wherein the second cemented carbide has higher porosity than the first cemented carbide.

12. The composite blank of claim 1, wherein the first material is cemented carbide, and the second material is steel or cermet.

13. The composite blank of claim 1, wherein the composite blank is in near net shape form.

14. A method of making a composite blank comprising:
forming a cutting portion of the blank from a first material, the cutting portion comprising flutes along an axial length of cut and one or more interior coolant channels extending along a central longitudinal axis of the blank;
forming a hollow shank portion of the blank from a second material; and
coupling the cutting portion to the hollow shank portion, wherein the first material differs from the second material in at least one property.

15. The method of claim 14, wherein the cutting portion and hollow shank portion are coupled by sintering to provide the composite blank a monolithic structure.

16. The method of claim 12, wherein the cutting portion and the hollow shank portion are in green powder form prior to the sintering.

17. The method of claim 16, wherein the green cutting portion and green hollow shank portion are formed by at least one of extrusion, molding and pressing.

18. The method of claim 14, wherein the first material is a first cemented carbide and the second material is a second cemented carbide.

19. The method of claim 18, wherein the first cemented carbide differs from the second cemented carbide in composition.

20. The method of claim 19, wherein the first cemented carbide comprises cubic carbides in an amount less than 0.3 wt. %, and the second cemented carbide comprises cubic carbides in an amount greater than 0.3 wt. %.

21. The method of claim 18, wherein the first cemented carbide and the second cemented carbide differ in average particle size.

22. The method of claim 21, wherein the first cemented carbide has an average particle size of 0.8 μm to 2 μm, and the second cemented carbide has an average particle size of 0.6 to 5 μm.

23. The method of claim 18, wherein the second cemented carbide has higher porosity than the first cemented carbide.

24. The method of claim 14, wherein the cutting portion and hollow shank portion are coupled by a braze joint.

25. A composite cutting insert comprising:
at least one non-working portion; and
at least one working portion extending from the non-working portion, the working portion including one or more interior coolant channels, wherein the working portion is formed of a first material differing in at least one property from a second material forming the non-working portion.

26. The composite cutting insert of claim 25, wherein the working portion and the non-working portion are continuous with one another.

27. The composite cutting insert of claim 25, wherein the one or more coolant channels extend along a central longitudinal axis of the cutting insert.

28. The composite cutting insert of claim 25, wherein the one or more coolant channels terminate in a cutting end of the insert.

29. The composite cutting insert of claim 25, wherein the first material is a first cemented carbide and the second material is a second cemented carbide.

30. The composite cutting insert of claim 29, wherein the first cemented carbide differs from the second cemented carbide in composition.

31. The composite cutting insert of claim 30, wherein the first cemented carbide comprises cubic carbides in an amount less than 0.3 wt. %, and the second cemented carbide comprises cubic carbides in an amount greater than 0.3 wt. %.

32. The composite cutting insert of claim 29, wherein the first cemented carbide and the second cemented carbide differ in average particle size.

33. The composite cutting insert of claim 29, wherein the second cemented carbide has higher porosity than the first cemented carbide.

34. A method of making a composite cutting insert comprising:
providing a core structure;
consolidating a powder composition around the core structure, the powder composition comprising a first grade powder and a second grade powder; and
sintering the powder composition to provide a working portion of the cutting insert formed of sintered first grade powder and a non-working portion formed of sintered second grade powder, wherein the sintered first grade powder differs from the sintered second grade powder in at least one property and the core structure is removed to provide one or more interior coolant channels in the working portion.

35. The method of claim 34, wherein the core is removed prior to sintering.

36. The method of claim 34, wherein the core is decomposed during sintering.
